(19) United States
(12) Patent Application Publication
(10) Pub. No.: US 2025/0187552 A1
(43) Pub. Date: Jun. 12, 2025

(54) DASH PANEL

(71) Applicant: TOYOTA JIDOSHA KABUSHIKI KAISHA, Toyota-shi (JP)

(72) Inventor: Satoru ABE, Okazaki-shi (JP)

(21) Appl. No.: 18/922,405

(22) Filed: Oct. 22, 2024

(30) Foreign Application Priority Data
Dec. 6, 2023 (JP) 2023-206512

(51) Int. Cl. B60R 13/08; B60K 37/20

(52) U.S. Cl. CPC B60R 13/0815; B60K 37/20

(57) ABSTRACT

A dash panel includes: a resin panel that is provided at a vehicle front portion and that partitions an interior of a vehicle cabin and an exterior of the vehicle cabin; and a dash silencer that is arranged at a surface at a vehicle cabin inner side of the resin panel and that is integrally molded with the resin panel.

### CROSS-REFERENCE TO RELATED APPLICATION

This application is based on and claims priority under 35 USC 119 from Japanese Patent Application No. 2023-206512, filed on Dec. 6, 2023, the entire disclosure of which is incorporated by reference herein.

### BACKGROUND

### Technical Field

The present disclosure relates to a dash panel.

### Related Art

Japanese Patent Application Laid-Open (JP-A) No. 2011-42310 discloses technology in which a dash silencer configured from a fiber laminated body is attached to a dash panel in which a plate-shaped member made of a steel plate is formed by press forming, using stud bolts.

### SUMMARY

In a dash panel equipped with a dash silencer, it is preferable to improve productivity of the dash panel and to improve sound insulation performance of the dash panel.

According to the present disclosure, a dash panel having improved productivity and improved sound insulation performance is obtained.

A dash panel according to a first aspect of the present disclosure includes: a resin panel that is provided at a vehicle front portion and that partitions an interior of a vehicle cabin and an exterior of the vehicle cabin; and a dash silencer that is arranged at a surface at a vehicle cabin inner side of the resin panel and that is integrally molded with the resin panel.

In the dash panel according to the first aspect, due to the dash panel including the dash silencer that is arranged at the surface at the vehicle cabin inner side of the resin panel and that is integrally molded with the resin panel, labor for attaching the dash silencer to the resin panel is eliminated. Furthermore, as compared to a case in which the dash silencer is attached to the resin panel, the dash silencer is better arranged at an intended position with respect to the resin panel. As a result, the productivity of the dash panel can be improved, and the sound insulation performance of the dash panel can be improved.

A dash panel according to a second aspect of the present disclosure is the dash panel according to the first aspect, wherein a panel opening portion that is formed at the resin panel is formed in a same position and with a same size as a silencer opening portion that is formed at the dash silencer, in a front view.

In the dash panel according to the second aspect, due to the panel opening portion formed at the resin panel being formed in the same position and with the same size as the silencer opening portion formed at the dash silencer, in a front view, the panel opening portion and the silencer opening portion are configured to have the same size. As a result, the sound insulation performance of the dash panel can be improved.

A dash panel according to a third aspect of the present disclosure is the dash panel according to the second aspect, wherein, at the resin panel, an opening edge that forms the panel opening portion is thicker than portions other than the opening edge of the resin panel.

In the dash panel according to the third aspect, due to the opening edge forming the panel opening portion being formed at the resin panel to be thicker than the portions other than the opening edge of the resin panel, the periphery of the panel opening portion is reinforced. As a result, a periphery of an opening of the dash panel can be reinforced with a simple configuration.

A dash panel according to a fourth aspect of the present disclosure is the dash panel according to the second aspect or the third aspect, wherein, at the resin panel, a rib is formed at a periphery of the panel opening portion.

In the dash panel according to the fourth aspect, due to the rib being formed at the periphery of the panel opening portion at the resin panel, the periphery of the panel opening portion is reinforced. As a result, the periphery of the opening of the dash panel can be reinforced with a simple configuration.

A dash panel according to a fifth aspect of the present disclosure is the dash panel according to any one of the first aspect to the fourth aspect, wherein the dash silencer is in contact with the resin panel over an entire surface thereof.

In the dash panel according to the fifth aspect, due to the dash silencer being in contact with the resin panel over the entire surface thereof, a gap is not formed between the dash silencer and the resin panel. As a result, rattling of the dash silencer can be avoided, and the sound insulation performance of the dash panel can be improved.

According to the present disclosure, the productivity of the dash panel can be improved, and the sound insulation performance of the dash panel can be improved.

### BRIEF DESCRIPTION OF THE DRAWINGS

Exemplary embodiments of the present disclosure will be described in detail based on the following figures, wherein:

FIG. 1 is a schematic diagram schematically illustrating a state in which a dash panel according to a first exemplary embodiment is attached to a vehicle;

FIG. 2 is an enlarged vertical cross-sectional view illustrating the dash panel according to the first exemplary embodiment;

FIG. 3 is an enlarged vertical cross-sectional view illustrating a dash panel according to a second exemplary embodiment; and

FIG. 4 is an enlarged vertical cross-sectional view illustrating a dash panel according to another exemplary embodiment.

### DETAILED DESCRIPTION

### First Exemplary Embodiment

A dash panel according to a first exemplary embodiment will be explained below with reference to the drawings. In the respective drawings, arrow UP indicates an upper side in an up-down direction of a vehicle, and arrow FR indicates a front side in a front-rear direction of the vehicle.

### Configuration of Dash Panel 40

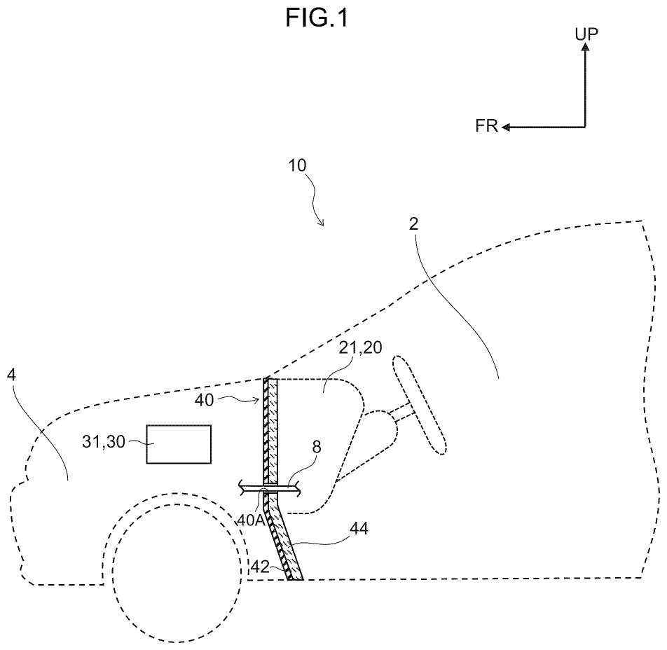

As shown in FIG. 1, a dash panel 40 is provided at a front portion of a vehicle 10, and partitions an interior of a vehicle cabin 2 and a front compartment 4 serving as an exterior of the vehicle cabin 2. The dash panel 40 is formed in a plate shape having a plate thickness direction along a vehicle front-rear direction, and partitions the front compartment 4 and the vehicle cabin 2 in the vehicle front-rear direction. An opening 40A that penetrates in the vehicle front-rear direction is formed at the dash panel 40.

An interior part 20 such as an instrument panel 21 or the like is provided at a vehicle front side of the interior of the vehicle cabin 2. An exterior part 30 such as a motor 31 or the like serving as a drive source is arranged at the front compartment 4.

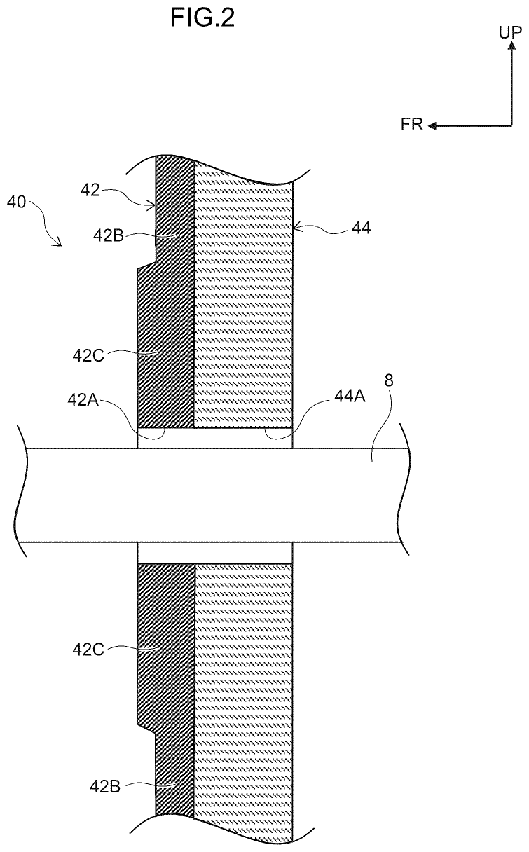

As shown in FIG. 2, the dash panel 40 includes a resin panel 42 and a dash silencer 44.

### Resin Panel 42

The resin panel 42 is made of resin and is formed in a plate shape having a plate thickness direction along the vehicle front-rear direction. The resin panel 42 is provided at the vehicle front portion and partitions the interior of the vehicle cabin 2 and the front compartment 4. The resin panel 42 is formed so as to have concavities and convexities in order to avoid interference with the interior part 20 and the exterior part 30.

Plural panel opening portions 42A are formed at the resin panel 42. The panel opening portions 42A are formed as through-holes that penetrate in the vehicle front-rear direction.

Opening edges 42C forming the panel opening portions 42A are formed to be thicker than other general portions 42B. In other words, the opening edges 42C are formed to have a thickness in the thickness direction that is greater than that of the general portions 42B other than the opening edges 42C of the resin panel 42. The opening edges 42C are formed so as to protrude from the general portions 42B toward the vehicle front. An insertion part 8, which will be described later, may be attached to the opening edges 42C.

### Dash Silencer 44

The dash silencer 44 is arranged at a vehicle rear side of the resin panel 42. The dash silencer 44 is arranged at a surface at a vehicle cabin inner side of the resin panel 42, and is integrally molded with the resin panel 42. The dash silencer 44 is in close contact with the resin panel 42, over an entire surface thereof. The dash silencer 44 is formed so as to have concavities and convexities in order to avoid interference with the interior part 20 and the exterior part 30.

The dash silencer 44 can be configured, for example, as a foam body made of resin. It should be noted that the dash silencer can be formed of a material that provides sound insulation performance and sound absorbing performance, and can be, for example, polyurethane, felt, a nonwoven fabric or the like.

Plural silencer opening portions 44A are formed at the dash silencer 44. The silencer opening portions 44A are formed as through-holes that penetrate in the vehicle front-rear direction. The panel opening portions 42A formed at the resin panel 42 and the silencer opening portions 44A formed at the dash silencer 44 are formed at the same positions and with the same sizes in a front view, and form the opening 40A of the dash panel 40.

The insertion part 8 arranged astride the vehicle cabin 2 and the front compartment 4 is inserted into the opening 40A of the dash panel 40. Examples of the insertion part 8 include a wire harness that couples the exterior part 30 and the interior part 20, an air conditioner duct, a brake operation device and the like.

### Method for Manufacturing Dash Panel 40

In the dash panel 40, the dash silencer 44 and the resin panel 42 are integrally formed by setting the dash silencer 44 as an insert article in a mold and performing insert molding in which a resin is filled around the dash silencer 44.

### Operation

The dash panel 40 according to the first exemplary embodiment includes the resin panel 42 that is made of resin, that is provided at the vehicle front portion, and that partitions the interior of the vehicle cabin 2 and the front compartment 4, and the dash silencer 44 that is arranged at the surface at the vehicle cabin 2 inner side of the resin panel 42 and that is integrally molded with the resin panel 42 (refer to FIG. 1).

Due to the dash panel 40 being provided with the dash silencer 44 that is arranged at the surface at the vehicle cabin 2 inner side of the resin panel 42 and that is integrally molded with the resin panel 42, labor for attaching the dash silencer 44 to the resin panel 42 is eliminated. Furthermore, as compared to a case in which the dash silencer 44 is attached to the resin panel 42, the dash silencer 44 is better arranged at an intended position with respect to the resin panel 42. As a result, the productivity of the dash panel 40 can be improved, and the sound insulation performance of the dash panel 40 can be improved.

Incidentally, openings for attaching vehicle parts (for example, brake operation devices, air conditioner ducts, harnesses and the like) that communicate between a front compartment 4 and an interior of a vehicle cabin 2 are provided in conventional dash panels made of sheet metal and dash silencers 44. In a case in which the dash silencer 44 is attached to the dash panel, an opening formed at the dash silencer 44 is formed to be larger than an opening formed at the dash panel, and absorbs variation in attachment of the dash silencer 44 to the dash panel. Therefore, there is a problem in that an area of the dash silencer 44 is reduced by an amount by which the opening is enlarged, and the sound insulation performance of the dash panel is reduced.

In the dash panel 40 according to the first exemplary embodiment, the panel opening portions 42A formed at the resin panel 42 are formed in the same positions and with the same sizes as the silencer opening portions 44A formed in the dash silencer 44, in a front view (see FIG. 2).

Due to the panel opening portions 42A formed at the resin panel 42 being formed in the same positions and with the same sizes as the silencer opening portions 44A formed at the dash silencer 44, in a front view, the panel opening portions 42A and the silencer opening portions 44A are configured to have the same sizes. As a result, the sound insulation performance of the dash panel 40 can be improved.

Incidentally, in a case in which the dash silencer 44 is attached to conventional dash panel formed of a steel plate, a fastener such as a clip or the like has been used. Therefore, at a portion that is not attached by the fastener, a gap is formed between the dash silencer 44 and the dash panel, and there has been a problem in that the dash silencer 44 rattles.

In the dash panel 40 according to the first exemplary embodiment, the dash silencer 44 is in close contact with the resin panel 42 over the entire surface thereof (refer to FIG. 2).

Due to the dash silencer 44 being in close contact with the resin panel 42 over the entire surface thereof, a gap is not formed between the dash silencer 44 and the resin panel 42. As a result, rattling of the dash silencer 44 can be avoided, and the sound insulation performance of the dash panel 40 can be improved.

Incidentally, in conventional dash panels, in a case in which a vehicle part is attached to an opening, it has been attached via a reinforcing part that reinforces a periphery of the opening of the dash panel. As a result, there has been a problem in that a number of parts increases, and a configuration becomes complicated.

In the dash panel 40 according to the first exemplary embodiment, the opening edges 42C forming the panel opening portions 42A are formed to be thicker than the other general portions 42B (refer to FIG. 2).

Due to the opening edges 42C forming the panel opening portions 42A being formed to be thicker than the other general portions 42B, the peripheries of the panel opening portions 42A of the resin panel 42 are reinforced. As a result, the peripheries of the openings 40A of the dash panel 40 can be reinforced with a simple configuration.

### Second Embodiment

A dash panel of a second exemplary embodiment is different from the dash panel of the first exemplary embodiment in that the configuration of the resin panel is different. It should be noted that portions that are identical or equivalent to those explained in the first exemplary embodiment will be explained using the same terms and the same reference numbers.

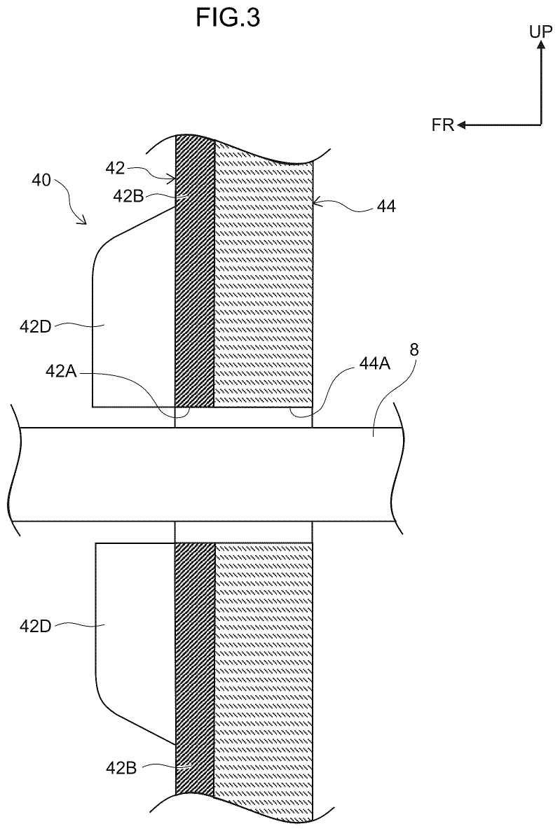

As shown in FIG. 3, ribs 42D that protrude from the general portions 42B toward the vehicle front are formed at peripheries of the panel opening portions 42A of the resin panel 42. Plural ribs 42D can be formed at the peripheries of the panel opening portions 42A.

Due to the ribs 42D being formed at the peripheries of the panel opening portions 42A of the resin panel 42, the peripheries of the panel opening portions 42A are reinforced. As a result, the peripheries of the panel opening portions 42A can be reinforced with a simple configuration.

It should be noted that other configurations and operational effects are substantially the same as those of the aforementioned first exemplary embodiment, and therefore, explanation thereof is omitted.

The dash panel according to the exemplary embodiments has been explained above based on the first exemplary embodiment and the second exemplary embodiment. However, the specific configuration is not limited to these exemplary embodiments, and design modifications and the like are permissible as long as they do not depart from the gist of the invention according to the respective claims.

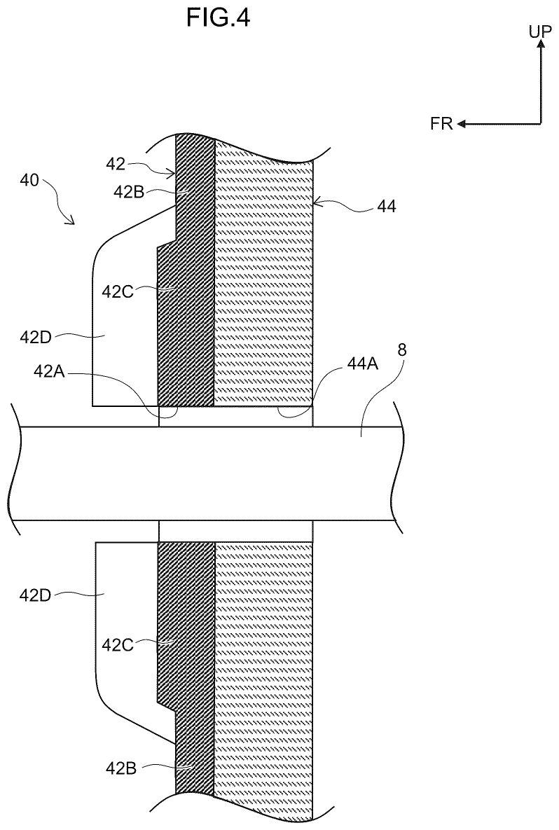

In the first exemplary embodiment, an example has been shown in which the opening edges 42C forming the panel opening portions 42A of the resin panel 42 are formed to be thicker than the general portions 42B, and in the second exemplary embodiment, an example has been shown in which the ribs 42D are formed at the peripheries of the panel opening portions 42A of the resin panel 42. However, as shown in FIG. 4, the opening edges 42C forming the panel opening portions 42A of the resin panel 42 may be formed to be thicker than the general portions 42B, and the ribs 42D may be further formed at the peripheries of the panel opening portions 42A of the resin panel 42. It should be noted that, in the resin panel 42, the opening edges 42C forming the panel opening portions 42A of the resin panel 42 do not need to be formed to be thicker than the general portions 42B, and the ribs 42D do not need to be formed at the peripheries of the panel opening portions 42A of the resin panel 42.

In the second exemplary embodiment, an example has been shown in which the ribs 42D protrude from the general portions 42B toward the vehicle front. However, ribs may protrude from the general portions 42B toward the vehicle rear, or may protrude from the general portions 42B toward the vehicle front and the vehicle rear.

What is claimed is:

1. A dash panel comprising:
a resin panel that is provided at a vehicle front portion and that partitions an interior of a vehicle cabin and an exterior of the vehicle cabin; and
a dash silencer that is arranged at a surface at a vehicle cabin inner side of the resin panel and that is integrally molded with the resin panel.

2. The dash panel according to claim 1, wherein a panel opening portion that is formed at the resin panel is formed in a same position and with a same size as a silencer opening portion that is formed at the dash silencer, in a front view.

3. The dash panel according to claim 2, wherein, at the resin panel, an opening edge that forms the panel opening portion is thicker than portions other than the opening edge of the resin panel.

4. The dash panel according to claim 2, wherein, at the resin panel, a rib is formed at a periphery of the panel opening portion.

5. The dash panel according to claim 1, wherein the dash silencer is in contact with the resin panel over an entire surface thereof.
